(19) United States
(12) Patent Application Publication
(10) Pub. No.: US 2013/0118017 A1
(43) Pub. Date: May 16, 2013

(54) MOTOR DRIVEN ROTATIONAL SAMPLING APPARATUS WITH REMOVABLE CUTTING TOOLS FOR MATERIAL COLLECTION

(71) Applicant: Joel S. Harris, Orleans (CA)

(72) Inventor: Joel S. Harris, Orleans (CA)

(73) Assignee: GE HEALTHCARE BIO-SCIENCES CORP., Piscataway, NJ (US)

(21) Appl. No.: 13/695,030

(22) PCT Filed: Apr. 30, 2010
(86) PCT No.: PCT/CA2010/000673

§ 371 Date: Jan. 18, 2013

(51) Int. Cl. G01N 1/08

(52) U.S. Cl. CPC G01N 1/08
USPC 30/130

(57) ABSTRACT

A motorized apparatus to simultaneously excise, retrieve, temporarily store and transport a sample of material has a hollow clamshell casing with a blended contoured grip for the fingers, a horizontal extension to eliminate slippage when held in a user's hand, and a flange bottom portion from which a removable cutting tool threaded to a drive shaft extends downwards. Within the clamshell casing an electric motor is mounted which drives, via gears, a drive shaft which rotates a cutting tool threaded to the distal end of the drive shaft. The end of the cutting tool, distal from the clamshell casing, forms a cutting edge circumscribing a circular region. An ejection rod slides reciprocally within the cutting tool between a stowed position and an expulsion position. Users core a sample from the source material by engaging contact between the cutting edge of the cutting tool and the surface of the source material, applying pressure against the surface of the source material while simultaneously activating the motor to rotate the cutting tool. The cutting region of the cutting tool passes through the source material contacting the support surface below the source material which urges the cored sample into the lumen of the cutting tool. The sample may be stored in the lumen or transported. Activation of the ejection rod moves from the stowed position towards the expulsion position displacing the temporarily stored sample from the lumen space in the cutting tool into the appropriate collection receptacle or onto a desired surface.

### BACKGROUND OF THE INVENTION

1. Field of Invention

Micro-sampling devices are used to retrieve a sample of material from a larger source material by some means such as slicing, cutting, scooping, punching, boring or coring. Examples would include punching a disc of paper from a sheet of paper, coring a piece of cloth from a larger piece of clothing, scooping gel from a petri dish, slicing a piece of tissue from a larger piece of tissue, etc. The retrieved samples may then be subsequently managed and further analyzed.

The widely available single-hole, manually operated office paper punch has been suitably adopted to sample different materials such as paper, leaves, etc., for scientific analysis. The paper punch consists of a punch/post sliding vertically through a biasing spring positioned between holes in two guide plates. The biasing spring keeps the punch/post in the stowed position above a bottom guide plate with a hole where the punch/post passes through to punch a sample from a source material placed over the bottom guide plate hole. A lever with a focrum is depressed, pushing down on the punch/post, bringing the two guide plates together and compressing the biasing spring positioned between them. The punch/post continues downward passing through the sample (e.g. paper) which rests on the bottom guide plate and over the bottom guide hole. As the lever is compressed further, the punch/post moves to the expulsion position punching a sample through the hole in the bottom guide plate with the punch/post also passing through the hole. As downward pressure is released from the lever, the biasing spring pushes the lever upward and returns the punch/post to the stowed position. Sampling of source materials is restricted to a fixed horizontal distance from the edge of the source material to a depth along the source material surface equal to the distance the source material can be inserted into the paper punch. The edge of the source material stops inside the paper punch at a fixed distance from where the punch/post and guide plate hole arrangement are located. The paper punch therefore restricts the horizontal distance the source material can be positioned between the punch/post and guide plate hole, therefore some areas on source materials of sizes larger than the horizontal distance it can be inserted into the paper punch cannot be sampled. Therefore it is not possible to sample at all locations on the surface of all sizes of source materials when using the office paper punch as a scientific sampling device. The thickness of source materials to be sampled is restricted to the vertical space between the top of the bottom guide plate hole and the bottom of the punch/post in the stowed position. This gap is referred to as the throat. The punching operation does not cut the sample but rather shears a sample equal to the area of the hole in the guide plate, tearing the sample from the larger source material as the punch/post passes through the source material and into the bottom guide plate hole. The tearing action during the sampling operation may result in the creation of residual artefact products (e.g. fibres, particles, etc., depending on the composition of the source material) originating from both the punched sample and source material. These artefact products may disperse away from the punch and/or collect on surfaces of the punch and may be removed with a brush or stream of air, for example. If, however, there is the presence of any static electricity, then any artefact products generated may adhere to surfaces on the punch and cannot be as easily removed. These artefact product may mix with newly punched samples produced on the same device and lead to cross sample contamination. An office paper punch may also be used to collect samples from leaves of some crops (i.e. corn, soya, cotton, sunflower, etc.). As this source material is a living plant tissue, the punching of a sample from a leaf creates artefact products from the leaf together with plant fluids which cause these artefacts products to adhere to the punch/post, bottom guide plate hole and other surfaces around the punching area that the leaf sample may come into contact. This requires the punch/post and bottom guide plate hole to be cleaned between subsequent sampling of different leaf source materials. This is the only way to eliminate cross sample contamination when this device is used to sample leaf products. As there is no means to attach a collection vial to the base of the hole in the bottom guide plate of these punches, the punched sample may randomly fall through the bottom guide plate hole and disperse onto different surfaces; onto other source material; and/or onto sampled material and may result in cross sample contamination. Therefore manual punch/post punches tear rather then cut samples and may generate cross sample contaminants and therefore are not suited as a viable sampling tool for scientific sample collection.

Electric bench top punches are used to sample paper storage cards which may store body fluids (e.g. saliva, blood, etc.). These punches operate with a similar punch/post and guide plate hole arrangement to that of the office paper punch, which also tears rather then cuts a sample from a source material and will also generate residual artefact products in the process. However, the electric punch also generates static electricity, due to the electricity operating the many moving parts in the punch, which may increase the random distribution of associated artefact products and increase the potential for cross sample contamination during the punching operation. The generated static electricity from these electric punches may also interfere or prevent delivery of the punched sample into the collection receptacle. It should be noted that collection receptacles on these bench top electric punching systems may not be positioned in intimate contact below the hole in the bottom guide plate. Consequently, the sample may free fall a short distance through the hole into the collection receptacle or travel down a closed delivery column into the collection receptacle. The generated static may cause the punched sample to adhere to the inside wall of the closed column and remain inside, or the punched sample may randomly disperse and adhere to other surfaces on the electric punch, when no closed delivery column is employed. The potential for static electricity and loss of control of the punched sample is dramatically increased when punching under dry conditions such as those associated with cold climates. Ultimately, under the aforementioned conditions, a punched sample may not be delivered to the collection receptacle; may become lost; or may be co-delivered to a collection receptacle with another sample upon subsequent punching of another source material. This may result in sample cross contamination. If the combination of static and artefact products are factored into the punching process then the potential for cross sample contamination is dramatically increased with punch/post punches which create static build-up. Although the artefact products generated may be minute, the sensitivity of the subsequent analysis may pick up these contaminants and render subsequent sample analysis inaccurate.

This new invention offers a combination of unique features including:
An electric motorized rotational coring operation thereby reducing repetitive stress to the user's hand which arises with manual punching and coring devices;
A rotational coring cutting tool which cuts a sample and does not generate residual artefact products during the coring process compared with a punch/post and guide plate hole mechanism, which tears a sample and generates artefact products which may lead to potential cross sample contamination between subsequently punched samples;
Fewer moving parts compared with bench top punching systems with no generation of static electricity build-up to affect sample delivery of cored samples;
Direct line of site for better management and control when delivering a cored sample to a collection site with the option of inserting the end of the cutting tool into a collection receptacle. Sample delivery from electric bench top punching systems and hand-held office paper punches may not allow for intimate contact between the bottom guide plate hole and a collection receptacle. In some electric bench top punches, the punched sample leaves the base guide plate hole, dropping down a short distance into a collection receptacle positioned under the bottom guide plate hole, but not in intimate contact with the bottom of the guide plate hole. The inability to remove this short distance and bring the collection receptacle into close, intimate contact with the underside of the bottom guide plate hole may result in a punched sample not dropping down vertically into the collection receptacle, resulting in sample delivery failure. Static electricity build-up which is created with each punching action on the electric bench top punch can further affect sample delivery due to the random movement of the punched sample from the generated static, which may cause the punched sample to adhere to a surface and not drop into the collection receptacle; to adhere to the base of the punch/post and not drop through the bottom guide plate hole; to remain in the guide plate hole following punching; or to be subject to other random displacement. This does not occur when coring and ejecting samples with the new invention;
A completely open line of sight in the new invention between the source material and the circular cutting area of the cutting tool and between the cutting tool and the collection receptacle when ejecting the cored sample from the cutting tool lumen into the collection receptacle. Electric bench top punches utilize a combination base plate sample stage to position and stabilize the source material (with the free hand) together with a guide plate hole for the punch/post to punch a sample. The added size of the sample stage may block an operator's view of the collection receptacle seated below the guide plate hole. In this configuration the operator must look below the sample stage following each punching action to confirm the punched sample has dropped into the collection receptacle;
The new invention does not use a punch/post and guide plate hole arrangement and does not require a sample stage to stabilize the source material, and therefore there is no visual restrictions from above the x-y plane of the source material being sampled and ejected into the collection receptacle. The electric bench top punches and paper punches restrict the location which can be punched on the surface of a source material. Also, the throat vertical height on both the electric bench top punch and the manual paper punch restrict the thickness of source material which can be inserted over the top of the bottom guide hole for punching and under the bottom of the punch post in the stowed position. The new invention does not have any restrictions on the thickness of source material which can be sampled;
Portability of the new invention allows the circular cutting area of the cutting tool on the new invention to be brought to a source material when source material cannot be brought to the new invention location (e.g. such as sampling evidence source material at a crime scene). Although the manual paper punch is also portable and can also be brought to sample source material in fixed locations, this prior art device can only sample limited locations on the surface of a source material and only on source materials of thicknesses which can be inserted into the throat between the top of the bottom guide plate hole and the bottom of the punch/post. The new invention is not only portable but can sample at any location on a source material of any thickness at any geographic location;
The ability to use an increased number of sampling diameters made possible by a plurality of removable cutting tools which can be threaded to the main body of the new invention;
The ability to simultaneous cut, retrieve and store the sample cored from a source material in the lumen of the cutting tool with the further option of transporting the sample while it is stored in the lumen;
An absence of repetitive stress injury (RSI) in the new invention, which is associated with manually operated punches;
Rapid change of cutting tools via a threaded connection; and,
Increased sampling speed compared with manually operated sampling devices and comparable sampling speed with electric bench top sampling devices.

2. Description of Prior Art

Paper punches such as the Fiskars® crafter's punch or other single hole stationary-type paper punch are widely available. The paper punch consists of a punch/post sliding vertically through a biasing spring positioned between holes in two guide plates. A biasing spring keeps the punch/post in the stowed position above a bottom guide plate with a hole where the source material is placed on top and the punch/post passes through to create the punched sample. These punches are designed with two levers articulated by a focrum. The bottom lever is fixed, supporting the bottom guide plate and hole. The top lever, when depressed, pushes the punch/post downward, bringing the two guide plates together compressing the biasing spring positioned between the two guide plates. The punch/post continues downward passing through the source material (e.g. paper) which rests on the bottom guide plate, over the guide hole. As the lever is further compressed the punch/post moves to the expulsion position punching a sample through the hole in the bottom guide plate. As pressure is released the biasing spring pushes the lever upward and returns the punch/post to the stowed position. The sampling area on the source material is restricted to a fixed horizontal distance from the edge of the source material to a depth along the surface of the source material equal to the distance the source material can be inserted into the paper punch where the edge of the source material stops inside the throat of the paper punch. The paper punch therefore restricts the horizontal distance the punch/post can be positioned over the source material from the edge of the source material. Therefore, areas on source materials of dimensions larger than the maximum horizontal distance the punch/post can reach, will not be possible to sample. Therefore, it is not possible to sample at all locations on the surface of all sizes of source materials using this punch. The thickness of source material to be sampled is restricted to the vertical space referred to as the throat, and located between the top of the bottom guide plate and the bottom of the punch/post in the stowed position. The punching operation does not cut the sample but rather shears a sample equal to the area of the hole in the bottom guide plate, tearing the sample from the larger source material. The tearing action of the sampling operation may result in the creation of residual artefact products (e.g. fibres, particles, etc., depending on the composition of the source material) originating from the punched sample and the source material during and following the punching operation. These artefact products may collect on surfaces of the punch, e.g. bottom guide plate. As there is no means to attach a collection receptacle to the base of the hole below the bottom guide plate, the punched sample may randomly fall through the hole and disperse onto different surfaces or may be co-delivered into a collection receptacle and result in cross sample contamination. The artefact products may build up around the bottom guide plate and also create potential cross sample contamination through mixing with subsequent sampled materials. Therefore punch/post punches tear rather then cut samples and may generate cross sample contaminants. Different punch/post and guide plate hole systems cannot be interchanged on the same main punch body and require purchasing a different punch/post and guide plate hole system for each size of punch required.

Manual paper punches such as those described in the prior art are not designed for sampling materials for subsequent scientific analysis and do not address the problems with artefact product generation which might compromise such analysis. These punches were designed to be used for hole punching documents or for crafts, but not for use as scientific sampling tools.

The punching action for the office paper punch occurs when the top and bottom levers are squeezed together in one hand, using the thumb on the top lever and the remaining fingers below on the bottom lever. Due to the tension of the biasing spring, this operation can create fatigue in the fingers, thumb, hand and wrist muscles after only a few sample punches are produced. This fatigue and muscle strain will increase over a lengthier period of repetitive punching with this type of punch. Therefore repetitive stress injury may develop quickly with this type of punch where even the smallest sampling pools to be collected becomes an arduous and painful task.

Another manual sample punch is the Harris Uni-Core™ (U.S. Pat. No. 7,093,508). This tool is constructed of a plastic barrel handle, a stainless steel sharpened coring tube formed from seamless stainless steel tubing and a spring operated ejection actuator. Each coring tool possesses a sharpened tube of fixed diameter and tubes are not removable. These tools may sample from any location along the surface of a flat source material. The sample is removed from a source material through manual downward pressure with optional rotation of the barrel and cutting tube in a clockwise and counter-clockwise direction. The sharpened tube passes through the source material and onto the surface of an underlying support. When the tube contacts the support, the support urges the cored sample into the lumen of the tube where it is retained until ejected using the actuator.

The Harris Uni-Core™ is a manually operated tool which is not designed for repetitive use, which can lead to repetitive stress injuries, if used for high throughput sampling. The sharpened cutting tubes are not interchangeable. This is a versatile sampling tool which can be used on a variety of source materials of any surface dimension enabling sampling from any location on the source material. However, the source material thickness and the composition impacts on the manual sampling tool's capability to core a sample from different source materials of differing thickness and composition. The electric rotation of the cutting tool in the new invention allows for a wider variety of source materials of different thickness and composition to be sampled.

Neonatal testing of newborns and paternity testing, as well as other routine blood sampling programs using blood storage cards, has necessitated the development of automated bench top punching systems to process these blood storage cards. Several automated punching systems are available from BSD Technologies (Australia), EMI (USA), Nanometrics (USA), Biorad (USA), and Wallac (USA). Each of these systems operates with a similar punch/post and guide hole arrangement and are designed to punch a sample disc from a blood storage card. These systems are only designed to sample blood cards and no other source material. The new invention is capable of sampling blood cards and other different types of source materials of different composition through a coring operation and not a punching operation.

In these prior art electric bench top systems the source material is restricted in size (i.e. FTA® blood storage card) to what can be hand fed and positioned on top of the combination sample stage/guide plate hole. The bench top punch is not portable and cannot be taken to the sample location. The new invention is portable allowing sampling of source materials at different geographic locations outside of the laboratory. The housing of the punch/post assembly on an electric bench top punching system, is configured to accept the dimensions of blood cards of a maximum fixed area and thickness, and therefore restricts the insertion of other source materials of larger size which cannot be inserted into the sample area of a bench top electric punching systems. These electric punches also create static electricity build up which may affect sample delivery and lead to potential sample cross contamination. These systems work with a punch/post and guide plate hole arrangement which creates artefact products from the source material and the sample punched due to the shearing action of the punch/post through the source material and then through the guide plate hole below the sample which tears the sample from the source material. The generated artefact products may remain on surfaces of the bench top punch, e.g. the punch/post, guide plate, etc., and be subsequently transferred to other samples following subsequent sampling of different source materials. This may lead to potential sample cross contamination.

A motorized rotational coring tool referred to as the Harris e-Core™ (U.S. Pat. No. 7,059,207) utilizes sharpened cutting tubes formed from seamless stainless steel tubing similar to that used on the Harris Uni-Core™. The Harris e-Core™ uses cutting tubes of fixed diameter specific for one Harris e-Core™ and cannot accept a different size diameter cutting tube. This restricts the user to one diameter of cutting tube per instrument. The new invention allows the user the option of using a wide range of cutting tools of different diameters on the same main unit. This increases the versatility of the unit for multiple sampling applications.

The new invention employs some of the novelties identified in the in the prior art Harris e-Core™. However, unlike the Harris e-Core™, the new invention uses removable circular cutting tools with a plurality of diameters which may be coupled to the body of the new invention by a threading action. This enables the new invention to generate samples of different diameters by accepting different replacement cutting tools of different diameters. The removable cutting tools cut samples from the source material and do not tear samples through the shearing action of a punch/post and guide plate hole arrangement and therefore do not generate the artefact products associated with the bench top electric punching process and which may result in cross sample contamination. The new invention is electric and a motor turns the removable circular cutting tool. This new invention may be operated in either hand. The new invention has fewer moving parts and the mechanism for sampling, driven by a motor, is accomplished in a smoother, continuous manner, with no generation of static electricity build up compared with prior art bench top electric punching systems. Therefore, the new invention is electric but does not generate the associated static characteristic of the larger electric automated punching systems. The motorized coring operation of the new invention eliminates the need to rotate the barrel by hand. Therefore, the potential for repetitive stress injury is reduced and/or eliminated, compared with the manual, prior art punching and coring tools. The new invention may be operated in one hand thereby allowing the source material to be positioned and stabilized with the other hand, similar to the electric bench top punches where the free hand is used to place the blood card on the combination sample stage and guide plate over the guide plate hole. The new invention offers the user total management and control of sample delivery following sampling. The prior art bench top electric punching units do not offer direct line of sight for confirming sample delivery following punching as the combination sample stage/guide plate hole is larger than the guide plates on paper punches, thereby blocking the operator's view of sample delivery into the collection receptacle below the guide plate hole. The new invention offers the unique capability of cutting, retrieving and storing the sample in the lumen of the cutting tool in one operation with the fourth option of transporting the sample while in the lumen of the cutting tool. This fourth operation does not occur simultaneously as does the first three operations but takes place when the new invention is lifted from the source material following sampling. This is similar to that of the prior art Harris e-Core™ and Harris Uni-Core™. The cored sample may now be directed into a collection receptacle and the operator can visually confirm delivery, which is not possible on the prior art automated electric bench top punching systems. This same feature for delivering the sample directly into a collection receptacle was first recognized on the Harris e-Core™. The new invention is designed to allow sampling of source materials of unrestricted size at unrestricted sample locations on the surface of the source material, and through a wide range of sample thicknesses using the same unit with replacement cutting tools, which is not possible on any prior art sampling systems including the Harris e-Core™. Also, the new invention ensures complete sample delivery management, eliminating sample loss and the potential for sample cross contamination as identified on electric bench top punching systems. The new invention eliminates repetitive stress injury and increases sample throughput. The cutting tools are replaceable on the same base unit of the new invention, allowing a wider number of different diameter cutting tools to be used on a single device which is not possible on the prior art Harris e-Core™ or electric bench top punching systems.

The new invention incorporates the original unique properties of the prior art Harris e-Core™ motorized coring tool with addition of a new novelty of using a plurality of different removable circular cutting tools of varying cutting diameters on the same unit which was not possible in the prior art. This new novelty of using different cutting tools on the same unit is accomplished by the use of a threaded coupling mechanism between the cutting tool and the drive shaft on the main unit. The prior art Harris e-Core™ requires different collets to hold different diameter cutting tubes to different main units. There is also a collet locking mechanism to facilitate replacement of collets and cutting tubes. A collet locking nut is also required to hold the collet and cutting tube onto the main unit. The collet size restricts the diameter of cutting tube which may be attached to the prior art Harris e-Core™ and limits the prior art to one or two sizes of diameter cutting tube per collet per Harris e-Core™. The replacement of cutting tubes requires more steps than simply threading and un-threading the cutting tool as is the method on the new invention. The fixed diameter of the ejection rod on the prior art Harris e-Core™ is available in different diameters and is retained in the new invention. However, in the prior art Harris e-Core™, only one or two closely similar diameter cutting tubes can be used with the same ejection rod diameter. The new invention uses the same diameter ejection rod but can now accept several different diameter cutting tools. This is accomplished by the use of a threaded coupling mechanism between the cutting tool and the main body of the new invention. This threaded coupling mechanism replaces the collet, collet locking mechanism, and the collet locking nut on the prior art Harris e-Core™. The new invention uses threaded removable circular cutting tools which can be simply threaded to the main unit requiring no additional parts for connections. This is the most significant new novelty change in the prior art Harris e-Core™.

The new invention continues to offer the same reduction in repetitive stress injury (RSI) to the fingers, hand and wrist as the prior art Harris e-Core™ due to the operation of an electric drive, rotating the cutting tool thereby eliminating lateral rotation of the wrist. The wrist does not become fatigued and sore, thereby allowing the Harris e-Core™ to be used for longer periods of time without injury. The wrist remains in the preferred neutral straight position when operating the motor driven coring device. Vertical downward motion translation is minimal as the design of this new invention places the cutting edge of the tubular cutting tool in close proximity to the surface of the source material to be sampled. The rotation of the circular cutting tool by the electric motor greatly reduces the required downward pressure, as the sharp edge of the circular cutting tool cores through the source material with minimal contact force. The hollow clamshell handle is vertical and can be held comfortably in either hand due to its ergonomic contoured shape. There is a thumb rest on the opposite side of the horizontal extension to rest the thumb when not punching or ejecting. At the base of the clamshell handle there is a transverse widening of the body. This allows the base of the hand gripping the instrument to rest on this flange. This hand rest at the base of the clamshell casing also acts to provide support and protection against the hand slipping into the sampling region. The tubular handle is modeled after the familiar joystick design. The wide use of joysticks for video gaming has resulted in the evolution of an ergonomic design that minimizes RSI. The rotation of the circular cutting tool is driven by two gears juxtaposed within the hollow clamshell casing. The motor output shaft is mated to a step down gear which reduces the speed of rotation of the output shaft. The electric driven circular cutting tool offers the necessary means to conduct high throughput sampling over continuous periods of time with minimal or no development of RSI. This high throughput is synonymous with that expected from the electric bench top punch devices discussed earlier. The sharp edge of the cutting tool area combined with the motor driven rotation of the cutting tool reduces the required downward pressure commonly needed when using the manual coring tools. The motor driven cutting tool will also allow for coring of thicker substrate materials without the required downward pressure used with the manual coring tools.

The lumen in the cutting tool in this new invention is large enough to allow for repeated coring of source material and the collection of several samples in the lumen without the need to eject the sample from the lumen before the next sample is cored from a new source material. This is not possible with punch/post punching systems.

A search did not disclose any prior art electric motorized rotational sampling tools with removable threaded cutting tools with a plurality of coring diameters which could be used on the same main unit and with the same ejection rod diameter.

### Canadian Patent Application

2,445,244 Harris

### United States

U.S. Pat. No. 7,059,207 Harris

### SUMMARY OF THE INVENTION

The present invention is a motor driven rotational sampling apparatus with removable cutting tools for material collection comprising a hollow clamshell casing with a contoured grip for the fingers, a horizontal curve extension to eliminate slippage when held in the palm of either hand, a thumb rest on top and a hand rest at the base of the hollow clamshell casing below where a threaded removable circular cutting tool extends downwards from a threaded drive shaft exposed at the base of the clamshell casing. The base of the drive shaft forms a threaded hollow volume to receive the threaded cutting tool. Within the clamshell casing an electric motor is housed which drives, via juxtaposed gears, the cutting tool in a rotational manner. The threaded end of the cutting tool threads into the hollow volume at the distal end of the drive shaft. A cutting edge circumscribing a circular region forms at the distal end of the cutting tool. A hollow volume extends the length of the cutting tool from the top to the base of the circular cutting region. An ejection rod slides reciprocally within the hollow volume of the drive shaft and hollow volume of the cutting tool between a stowed position and an expulsion position. When the ejection rod moves from the stowed position to the expulsion position it will extend past the circular cutting region of the cutting tool and expel any sample contained within the hollow volume of the cutting tool. The hollow volume within the cutting tool is referred to as the lumen. A user cuts a sample from a source material resting on a flat support, using the circular cutting region of the cutting tool when the ejection rod is in the stowed position. As the circular cutting region of the cutting tool makes contact with the source material through downward pressure, the thumb activates the motor activation button which rotates the cutting tool. A sample is cored from the source material and as the coring tool passes through the source material and contacts the underlying support, the sample is urged into the lumen of the cutting tool to be temporarily stored. The cutting tool is then raised from the source material using the free hand to hold the source material down and strip the cutting tool cutting region from the source material. As the circular cutting tool is removed from contact with the sample material the thumb is removed from the motor activation button causing the rotation of the motor to stop and the cutting tool to stop rotating. Once the source material has been cut it is simultaneously extracted and lodged within the lumen of the cutting tool. The extracted sample remains lodged in the lumen of the cutting tool until the user depresses the ejection rod button at the top of the clamshell casing, extending the ejection rod which passes through the lumen of the cutting tool to the expulsion position. As the ejection rod moves from the stowed position to the expulsion position it will eject the sample from the lumen of the cutting tool. The automatic return of the eject rod is comprised of a compression spring which biases the ejection rod in the stowed position. The sample in the lumen can remain temporarily stored and/or may be transported while stored in the lumen. A cutting tool with a hollow volume defined as the lumen, above the circular cutting region, can be removably supported when torque threaded to the threaded hollow volume of the drive shaft. Reverse threading of the cutting tool from the drive shaft allows the cutting tool to be removed and replaced with another cutting tool of different diameter circular cutting region.

Samples may be collected from source materials of different sizes, thicknesses and at different geographic locations due to the portability of the new invention. The body of the new invention is a symmetric design allowing it to be held comfortably in either hand like a video game joy stick, with the base of the hand resting on the enlarged flange at the base of the hollow clamshell casing. The grip is grasped in the palm with the front fingers wrapped around the blended contours with the thumb resting on a flat area at the top and to the rear of the hollow clamshell casing. The new invention may be operated with either hand. This ergonomic design avoids using the wrist in a bent (flexed), extended, or twisted position for long periods of time. The unit has been sculpted to complement the contours of the human hand, and the design of the apparatus allows the wrist to maintain a neutral (straight) position. The whole hand is used to grasp the handle and can sit on an enlarged hand rest extending horizontally at the base in a blended design. The thumb also rests on a flat area within easy reach of the activation and ejection buttons located at the top of the clamshell casing. The device is symmetrical, thus equally usable in a one-handed manner by either hand.

In this invention, the removable threaded cutting tool serves four functions: first the cutting tool cores a sample via the rotation of the drive shaft connected to the motor by way of gears and which the cutting tool is threaded; secondly, the tool retrieves the sample through the coring and downward pressure on the support below the source material which urges the sample into the lumen, thereby allowing the sample to be picked up by the cutting tool; thirdly the lumen acts as an internal storage chamber to hold the sample prior to preferential ejection; fourth the lumen in the cutting tool allows the sample to be transported while held in storage in the lumen. The sample ejection system enables quick, safe and clean removal of the sample from the lumen in the cutting tool. The electric drive eliminates manual exertion in the horizontal plane by eliminating the need for the reciprocating rotary motion of the hand and wrist needed to core a sample from the source material with a manually operated coring punch. Eliminating the wrist action in this new invention allows for the operation of the device with the wrist in the neutral or straight position, eliminating stress to the hand. The hollow casing is held by the entire hand and not the fingers, again reducing another contributing source of wrist and hand stress by dispersing the muscle action to hold the unit over the entire hand and not a few fingers.

This invention may use a plurality of removable cutting tools of different diameter so that a single cutting tool is threaded to the drive shaft at the distal end of the apparatus below the hand rest. The threaded coupling of the cutting tool to the drive shaft allows for rapid exchange of cutting tools through a threading and un-threading operation. Thereby allowing numerous different diameter cutting tools to be used on a single drive shaft and unit.

The addition of a motor to rotate the cutting tool, together with the ergonomic design of the clamshell casing, significantly reduces repetitive stress related injury resulting from prior art manual coring and punching devices. The electric motor used to rotate the cutting tool eliminates the reciprocating rotary action of the wrist required to operate the Harris Uni-Core™. The hollow clamshell casing allows the unit to be comfortably gripped in the palm of either hand with the fingers wrapped in front and the thumb on top similar to gripping a video game joystick. This is a recognized grip design people are familiar with, given the widespread use of joysticks, and also similarly designed scientific instruments such as the Eppendorf® pipetters, thereby making this invention less foreign when initially used and easily accepted to the hand. The positioning of the activation trigger is such that it can be easily reached with the thumb of either hand, minimizing strain and adding versatility.

The motorized rotation of the cutting tool and ergonomic clamshell casing design allows for repeated sampling with minimal strain to the hand. This design also yields an increased sampling range as the invention is capable of sampling a wider variety of source materials of increased thicknesses and dimensions. The tool is designed to accommodate a plurality of cutting tools of different size.

The cutting tool can be released from the drive shaft simply by gripping the outside end of the drive shaft and the body of the cutting tool and rotating in opposing directions, thereby loosening the thread coupling to un-thread the cutting tool.

The arrangement and locations of the activation and ejection rod buttons leaves one hand free. This allows the operator to position and hold the source material on the underlying support, and, following sampling, to hold a collecting receptacle while the opposite hand ejects the sample from the cutting tool lumen into the receptacle held in the opposing hand.

The present invention allows the user to portion appropriate size samples from source materials such as food, agricultural products, gels, clothing, paint chips, film, paper, human or animal tissue and substrates bearing source materials to be sampled such as ink on paper, blood on filter paper, blood on cloth, other biological stains on cloth, and the like. This present invention may also be used to create circular shapes of varying size and thickness for use in other applications, such as creating micro-filters from large samples of filter paper. Sampling is accomplished by placing the desired source material on the surface of a support (e.g. rubber cutting mat) and penetrating the source material to be sampled with a sharp cutting tool by applying gentle downward pressure with the motor activated thereby coring a sample from the source material. The rotating cutting tool passes through the source material contacting the surface below the substrate, which urges the sample into the lumen of the cutting tool. The underlying surface below the substrate can be any flat surface supporting the source material. These and other advantages of the invention will be more particularly realized by reading the following detailed description of the invention together with the drawings in which like reference numerals refer to like parts throughout.

### BRIEF DESCRIPTION OF THE DRAWINGS

FIG. 1 is an isometric view showing a preferred embodiment of a sample collection apparatus constructed in accordance with the principles of the invention, with a threaded drive shaft to hold threaded removable cutting tools, the motor actuator button, the ejection button, the hand rest at the base of the grip, finger contours at the top and to the front of the grip and a horizontal extension extending in the front and above the finger contours to eliminate slippage when held in a user's hand.

FIG. 2 is an overhead view along the primary axis of the hollow tubular clamshell casing.

FIG. 3 is a projected front view of the apparatus, showing the motor actuation button and ejection button, drive shaft and threaded removable cutting tool.

FIG. 4 is a projected side view, with some detail removed for clarity (motor drive assembly), showing the contents of the right hand side of the hollow clamshell casing. This view includes the ejection button, compression spring, ejection shaft, gears, bearings, drive shaft and threaded removable cutting tool.

FIG. 5 is a projected side view, with some detail removed for clarity (i.e. ejection assembly), showing the contents of the left hand side of the hollow clamshell casing. It includes the motor actuation button, motor, gears, and power cord.

FIG. 6 is an exploded view of the apparatus, showing the details of the sub-assemblies in the apparatus.

FIG. 7 is an isometric view of the apparatus held in the right hand in the operation of extracting a sample from a source material. The thumb operates the motor actuation button and the ejection button. This view shows a preferred embodiment of a sample collection apparatus constructed in accordance with the principles of the invention, with the drive shaft and threaded removable cutting tool, the motor actuator button, the ejection button, the hand rest at the base of the grip, finger contours at the top and to the front of the grip and a horizontal extension extending in the front and above the finger contours to eliminate slippage when held in a user's hand.

FIG. 8 is an overhead view along the primary axis B-B of the hollow clamshell casing.

FIG. 8A is a partial view of section B-B in the lower portion of the apparatus showing the ejection rod in the stowed position within the removable cutting tool which is threaded to the distal end of the drive shaft.

FIG. 8B is a partial view of section B-B in the lower portion of the apparatus showing the ejection rod in the stowed position within the removable cutting tool which is threaded to the distal end of the drive shaft. The ejection rod is in the stowed position following the coring of a sample disc which is retrieved into the lumen below the distal end of the ejection rod and above the distal end of the threaded removable cutting tool.

FIG. 8C is a partial view of section B-B in the lower portion of the apparatus, showing the drive shaft, removable cutting tool threaded to the distal end of the drive shaft and the ejection rod in the expulsion position following the ejection of the sample disc from its stored location in the lumen as seen in FIG. 8B.

FIG. 9 is an isometric detail view of the drive shaft and the threaded removable cutting tool threaded partially to the distal end of the drive shaft disclosing the threading at the top of the cutting tool.

FIG. 9A is a partial detailed view of the apparatus along the axis A-A of the drive shaft and threaded removable cutting tool, as seen from the bottom.

FIG. 9B is a projected section view of the drive shaft and the threaded removable cutting tool threaded to the drive shaft along axis A-A of the drive shaft and removable cutting tool.

FIG. 10 is an isometric view of the apparatus held in the right hand with the threaded removable cutting tool above a collection receptacle. The thumb depresses the ejection button, expelling the sample from the lumen of the cutting tool into the desired location. The ejection rod is in the expulsion position extending beyond the distal end of the cutting tool.

### DETAILED DESCRIPTION OF PREFERRED EMBODIMENTS

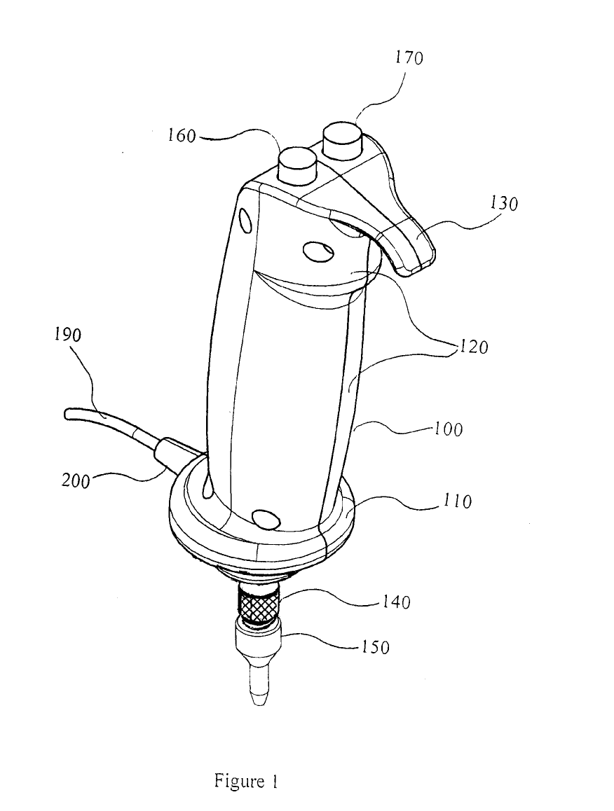

Referring to FIG. 1, a preferred embodiment of a sample collection device constructed in accordance with the principles of the invention is shown. A handle feature 100 blends to a horizontal flange feature 110 at the bottom as a hollow clamshell casing. A drive shaft 140 with its lower end below the flange 110 holds the threaded removable cutting tool 150. To facilitate ease of holding the unit, finger contours 120 are included on the front of the casing. To eliminate slipping of the hollow clamshell handle 100 through the hand a horizontal extension 130 has also been added as a blended feature above the finger contours 120. The motor actuation button 160 and the ejection button 170 are positioned at the top of the hollow clamshell casing 100. The power supply cord 190 extends from a cord strain release 200 which extends from the rim of the flange 110.

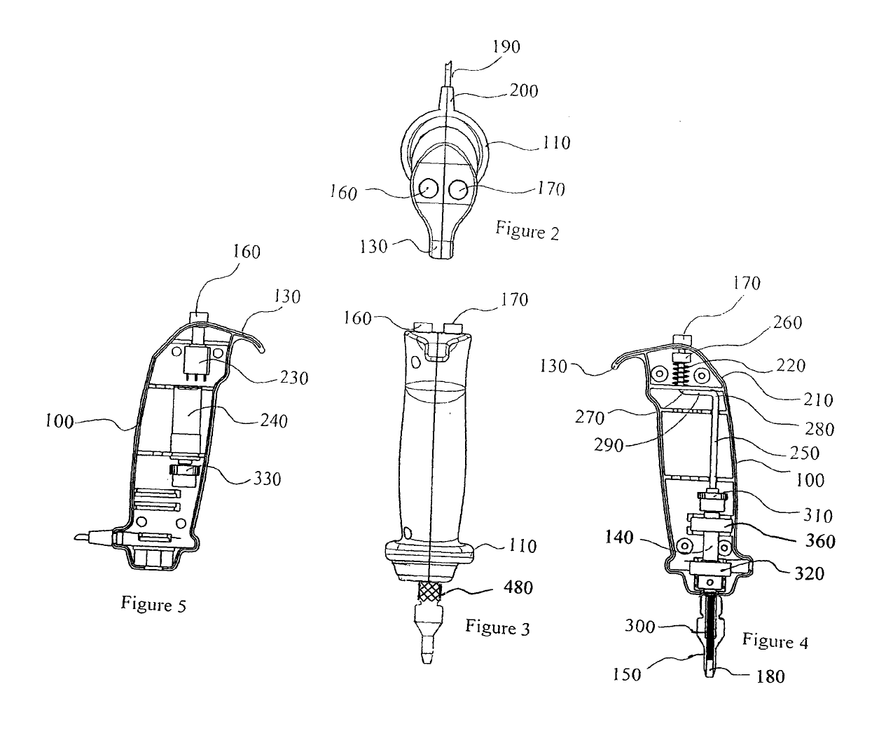

FIGS. 2 and 3 repeat the preferred embodiments described in FIG. 1 but are an overhead view and a projected front view of the hollow clamshell casing 100 showing the motor actuation button control 160, ejection button 170 and drive shaft 140 with its lower end below the flange 110 with the threaded removable cutting tool 150.

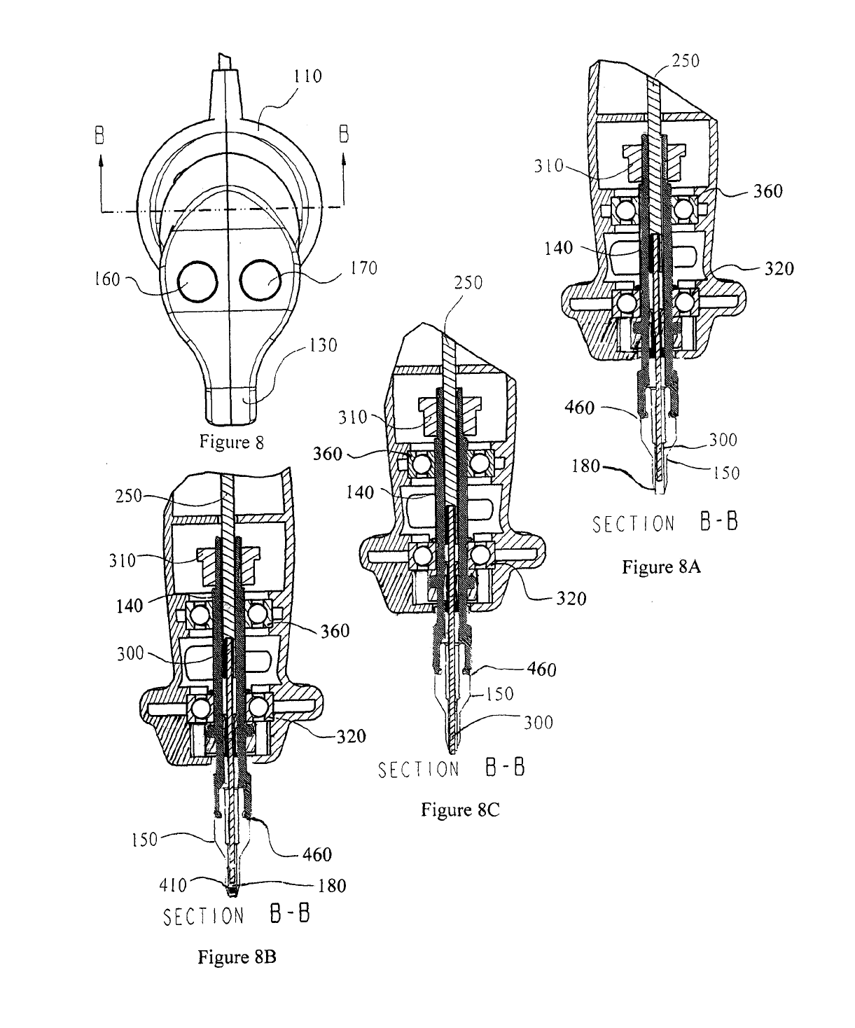

FIG. 4 shows a projected side view of the apparatus in which the thumb rest 210 can be better realized at the upper end of the hollow clamshell casing 100. The ejection button 170 is biased in the stowed position by a compression coil spring 220. The ejection rod 300 is recessed in the threaded removable cutting tool 150. Thumb rest 210 is positioned below, and on an angle from the motor actuation button 160 and ejection button 170. A push button, normally open, momentary switch 230 (see FIG. 5), which activates the gear motor 240, is positioned below the motor actuation button 160 (see FIG. 5). The ejection button 170, located at the top of the vertical blended boss on the hollow clamshell casing 100, is attached to an ejection shaft 250. The ejection shaft 250 is attached to shaft collar 260 which is biased by spring 220, shown in the stowed position. Ejection shaft 250 includes 2 opposing co-planar 90° bends 270 and 280, separated by a short horizontal span 290 to axially align the ejection rod 300 with the threaded removable cutting tool 150. The ejection shaft 250 passes through the gear 310 terminating within primary drive shaft 140. The ejection rod 300 is pressure fitted into the ejection shaft 250 within primary drive shaft 140 (see FIGS. 8A to 8C). Gear motor 240 has a gear 330 (see FIG. 5) meshing with gear 310 on drive shaft 140. The primary drive shaft 140 is located between two bearings 360 (upper) and 320 (lower).

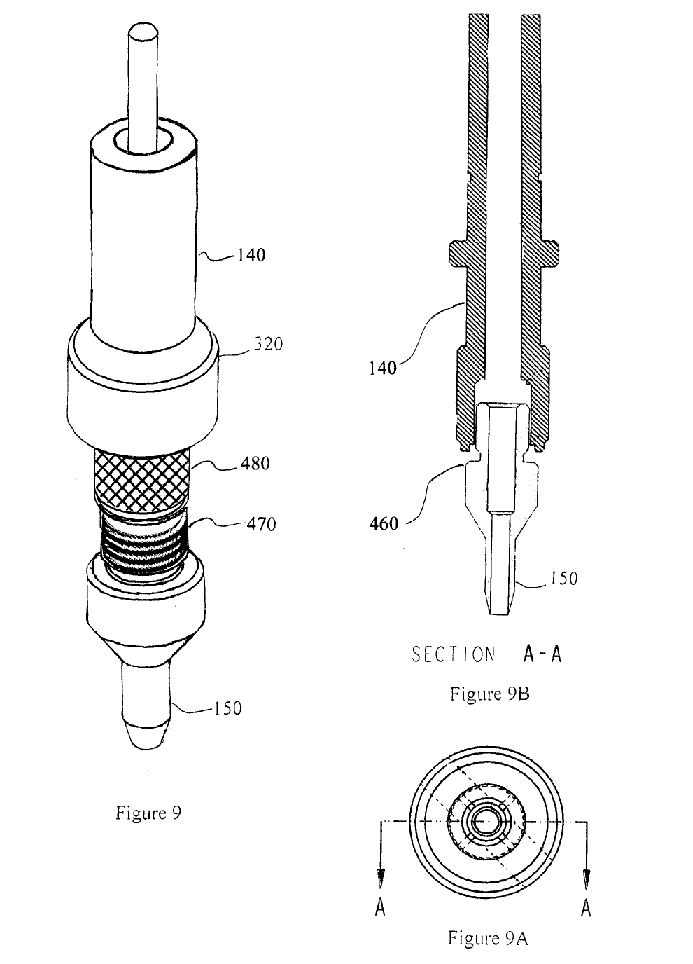

FIG. 5 repeats the preferred embodiments described in FIGS. 1 to 4 and is a projected side view of the hollow clamshell casing 100. When motor actuation button 160 is depressed it activates the push button switch 230 to start gear motor 240, which drives gear 330 which meshes with gear 310 and turns drive shaft 140 and threaded removable cutting tool 150. When ejection button 170 is depressed it compresses spring 220 and causes ejection shaft 250 with attached ejection rod 300 to travel from the stowed position to expulsion position. Holding the cross hatched 480 (see FIGS. 3 and 9B) surface of the lower end of drive shaft 140 firmly to restrict rotation and then turning threaded removable cutting tool 150 in a counterclockwise rotation will loosen the thread coupling between the internal thread at the lower end of the drive shaft 140 and the external thread 470 on the removable cutting tool 150 (see FIG. 9). This allows for a plurality of threaded removable cutting tools 150 of different diameters to be threaded to the primary drive shaft 140 and to use a fixed diameter ejection rod 300 (See FIGS. 8A and 8C).

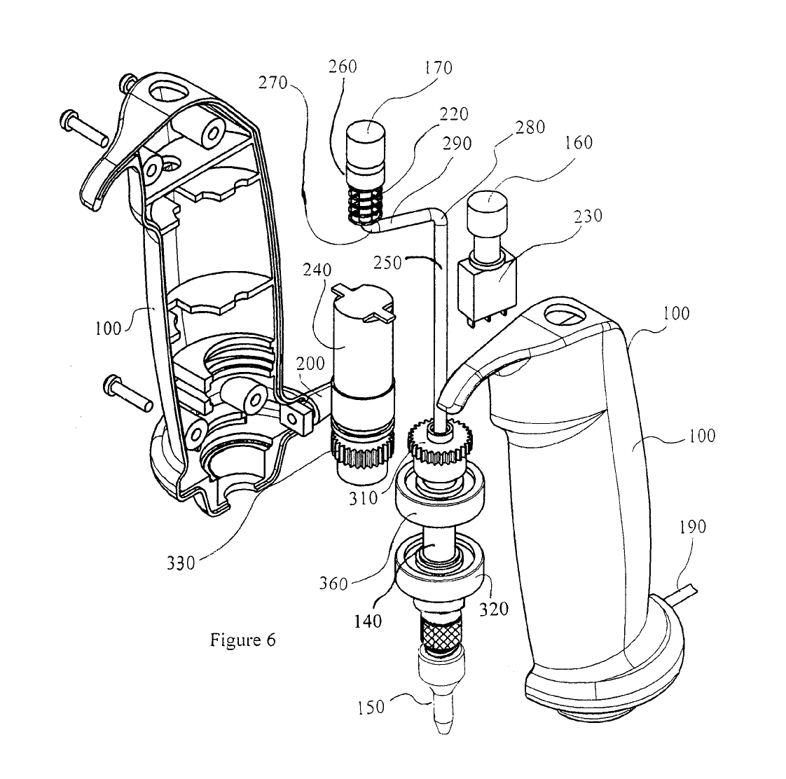

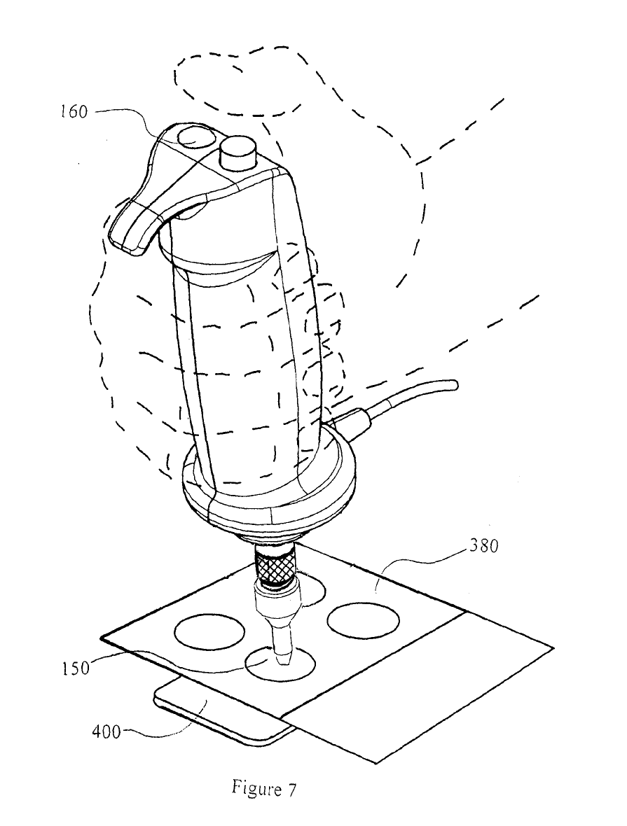

FIG. 6 is an exploded view with both sides of the clamshell casing 100 moved to reveal the drive sub-assembly. Electrical power is provided to a low voltage gear motor 240 from power cord 190 via the push button switch 230. A gear 330 is attached to the output shaft 370 (within gear motor 240 and not shown) of the gear motor 240 in position to mesh with another gear 310 on the primary drive shaft 140. The use and configuration of standard gears 310 and 330 in this embodiment enables the hollow clamshell casing 100 to be in an ergonomically suitable configuration for the hand to hold above the source material 380 (see FIG. 7). The primary drive shaft 140 is located between two bearings 360 (upper) and 320 (lower). The upper bearing 360 is used to maintain correct radial alignment of gears 310 and 330 and the lower bearing 320 is positioned to suit the axial forces expected during sample coring. The lower end (see FIGS. 8A to 8C) of the primary drive shaft 140 is threaded internally to receive a threaded removable cutting tool 150.

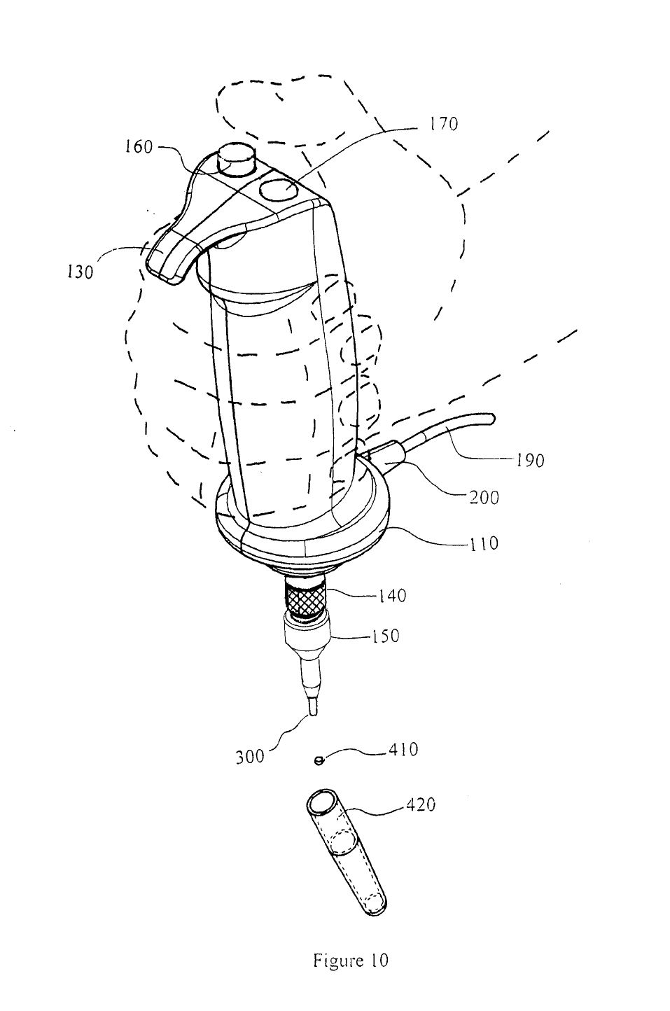

FIG. 7 is an isometric view of the apparatus held in the right hand, showing the threaded removable cutting tool 150 above a source material 380 to be sampled. Source material 380 rests on top of a support 400. The motor actuation button 160 is depressed to activate the motor 240, which drives the threaded removable cutting tool 150. Holding the clamshell casing grip, gentle downward pressure is applied and a sample is cored from the source material 380. A sample 410, having been cut as described above, is urged into the lumen 180 (see FIG. 8B) and temporarily stored until ejected. Sample 410 is shown ejected from lumen 180 beyond the distal end of threaded removable cutting tool 150 into sample collection receptacle 420 (See FIG. 10).

FIG. 8 is a top view of the apparatus, looking along the axis B-B of the sample sleeve 150. FIG. 8A is a detailed section view of FIG. 8 showing the internal sub-assemblies with the ejection rod 300 in the stowed position and the lumen 180 below the distal end of the ejection rod 300 and above the distal end of cutting tool 150 prior to sampling source material 380.

FIG. 8B is a detailed section view of FIG. 8 showing the internal sub-assemblies with the ejection rod 300 in the stowed position following the coring of a sample 410 from source material 380 (see FIG. 7) with the cored sample 410 in lumen 180 below the distal end of the ejection rod 300 and above the distal end of cutting tool 150.

FIG. 8C is a detailed section view of FIG. 8 showing the internal sub-assemblies in the expulsion position. The ejection rod 300 is shown in the expulsion position with a compressed spring 220 biasing the ejection shaft 250 and ejection rod 300 towards the expulsion position. The distal end of ejection rod 300 extends beyond the distal end of cutting tool 150 to eject sample 410 from temporary stored location in lumen 180 (see FIG. 10).

FIG. 9 is an isometric detailed view of the threaded cutting tool 150 partially threaded to primary drive shaft 140, showing the external thread 470 on cutting tool 150 and showing the lower bearing 320.

FIG. 9A is a bottom view, looking up along the axis A-A of the threaded cutting tool 150 coupled to drive shaft 140.

FIG. 9B is a projected section view of the threaded cutting tool 150 threaded to primary drive shaft 140. The cutting tool 150 is threaded into the lower end of the primary drive shaft 140 until it cannot be threaded further when the distal end of primary drive shaft 140 contacts shoulder 460 on the cutting tool 150. When the cross hatched surface 480 (see FIG. 9) at the lower end of the drive shaft 140 is held firmly with fingers, the cutting tool 150 can be threaded firmly to the drive shaft 140 or un-threaded and loosened from drive shaft 140. A plurality of cutting tools 150 of different diameters can be threaded to the same drive shaft 140 and use the same ejection rod 300 of fixed outside diameter.

FIG. 10 is an isometric view of the apparatus with the ejection rod 300 in the expulsion position. Sample 410 has been ejected by ejection rod 300 from its temporary storage in the lumen 180 of cutting tool 150 (see FIG. 8B) and is preferentially delivered to receiving vial 420. Note ejection button 170 is depressed.

A preferred embodiment of this invention is the threaded coupling of the cutting tool 150 to the distal end of the primary drive shaft 140. This coupling method allows for a plurality of different diameter cutting tools 150 to be connected to the same primary drive shaft 140 and to use the same ejection rod 300.

A preferred embodiment of this invention is the ergonomic design in FIGS. 4, 5 and 6. This design presents a symmetric shape allowing the device to be constructed such that it is ergonomically sculpted to be held in either hand, in a comfortable position with the hollow clamshell casing 100 resting in the palm of the hand with fingers positioned within the front contours 120 and under the horizontal extension 130 which rests over the forefinger, and thumb resting on an angular flat surface 210 at the top and to the rear of clamshell casing 100. This design is similar to the grip of a video game joystick which is designed for long, repetitive use and minimal repetitive stress.

Another preferred embodiment is the design of the threaded removable cutting tool 150 which is constructed to sample a wide range of source materials 380 of varying density and thickness.

Another preferred embodiment is the combination of sharp cutting edge and rotational coring action of the cutting tool 150 which cuts and does not tear a sample 410 as occurs with punch/post and guide plate hole punches, thereby eliminating the generation of sampling artefact products and potential cross sample contamination with repeated sampling.

Another preferred embodiment is the volume size of the lumen 180 between the distal end of the stowed ejection rod 300 and above the distal end of the cutting tool 150 which can hold more that one sample 410 prior to ejection.

Another preferred design of this invention is that it allows sample 410 to be collected from any size source material 380 and from any location on the source material 380.

Another preferred embodiment is the multi-functionality of the cutting tool 150 which simultaneously cuts a sample 410 from a source material 380, retrieves the cored sample 410 and stores sample 410 in the lumen 180, in a single operation which is immediately followed by a fourth operation, the transport of the sample, while stored in lumen 180, as the unit is lifted from source material 380 following completion of sampling.

Another preferred embodiment is the use of the compression spring 220 to bias the ejection shaft 250 in the stowed position. In high throughput situations, the ejection of sample 410, can be completed rapidly, for quick removal of sample 410 from lumen 180, to allow for rapid sampling of another source material. Alternatively, the ejection of sample 410 from lumen 180 in cutting tool 150, may be performed more slowly, gently depressing the ejection button 170 to slowly move ejection rod 300 from its stowed position down lumen 180 for gradual movement of sample 410 out of the cutting tool 150 for careful positioning of sample 410 onto sample stages or glass slides where speed is not required.

Still another preferred embodiment arising from the motorized rotation of the invention is the heavy duty construction of the cutting tool 150 which allows for thicker source material 380 to be sampled without creation of artefact products. This increases the versatility of the invention compared with the prior art manually operated coring tools which require increased downward pressure and also increase the potential for repetitive stress injury to fingers, hand and wrist which does not occur in the new invention.

Another preferred embodiment is the reduced number of moving parts which reduces or eliminates the generation of static electricity, commonly associated with large, multi-component electric bench top punch/post punching systems. The new invention produces no static electricity and no artefact products and therefore the potential cross sample contamination is virtually eliminated between samples.

The present embodiments allow the entire sample 410 to be ejected from cutting tool 150 into a collection receptacle 420, without manually working the sample 410 free from cutting tool 150. The sample 410 is cut and retrieved in a single, simultaneous step, without use of tweezers to lift sample 410 from source material 380 or to remove sample 410 from lumen 180. The sample 410 can be ejected in a rapid or slow manner on demand from lumen 180.

As shown in FIG. 6 the motor driven rotational sampling apparatus with the cutting tool 150 is comprised of a hollow clamshell casing 100, a threaded cutting tool 150 attached to the drive shaft 140, ejection shaft 250, with motor 240. Motor 240 is used to rotate cutting tool 150 to core a sample 410 from a source material 380, which is urged into the lumen 180 of cutting tool 150 and held within the cutting tool 150. Sample 410 can be ejected by ejection rod 300 from cutting tool 150 and lumen 180 when ejection button 170 is depressed. Ejection rod 300 is pressure fitted into the ejection shaft 250.

The design of a motor driven rotational sampling apparatus with cutting tools in FIG. 1 is such that the hollow clamshell casing 100 rests comfortably in the palm of either hand with the fingers resting on the contours 120 in front and under horizontal extension 130 with the thumb on a flat surface 210 at the top and to the rear. The base of the hand rests on a flange 110 at the base of the hollow clamshell casing. The wrist is maintained in a neutral, straight position and the hand grasps the hollow clamshell casing 100 to lift and lower the unit for coring. No rotation of the hand or wrist is required for sample collection, therefore there is minimal repetitive stress in the wrist.

I claim:

1. An electric motor driven rotational sampling apparatus with threaded removable cutting tools to collect a sample comprising:
a hollow clamshell casing having a top portion, a bottom portion and a tubular handle portion connecting said top portion to said bottom portion;
a threaded primary drive shaft connected to said bottom portion of the casing adapted to receive a plurality of threaded removable cutting tools;
said threaded removable cutting tool extending downward from the casing, at distal end of said cutting tool forming a cutting edge circumscribing a circular cutting region;
an ejection rod being reciprocally slidable within said cutting tool from a stowed position to an expulsion position past said cutting edge;
an electric gear motor deposed within the casing;
motor actuation means to drive a first and second gear deposed within the casing and thereby rotating said cutting tool to collect a sample from a source material when the cutting edge contacts said source material;
ejection means to move said ejection rod from the stowed position to the expulsion position to displace said sample from the cutting tool, and
a threaded coupling mechanism deposed below said bottom portion of said casing, for removal of said threaded cutting tool and replacement with a plurality of threaded cutting tools.

2. The apparatus of claim 1, wherein said handle portion comprises contours designed to accommodate a left or a right hand of a user.

3. The apparatus of claim 1, wherein said top portion of the casing further includes a horizontal projection extending from a side of the apparatus.

4. The apparatus of claim 3 comprising a flanged bottom portion of the casing.

5. The apparatus of claim 1, wherein said gear motor comprises an output shaft and a primary drive shaft wherein said first gear is attached to the output shaft and said second gear is attached to said primary drive shaft, said first gear is radially aligned and in meshing engagement with said second gear.

6. The apparatus of claim 5, wherein said threaded coupling mechanism comprises a primary drive shaft and a cutting tool wherein the cutting tool is threaded to the primary drive shaft locking the cutting tool to the primary drive shaft.

7. The apparatus in claim 5, wherein said ejection rod is pressure fit in an ejection shaft.

8. The apparatus in claim 7, wherein said ejection shaft is disposed within said primary drive shaft, said ejection shaft connected to said ejection means.

9. The apparatus in claim 8, including biasing means to bias said ejection shaft and ejection rod in said stowed position.

10. The apparatus in claim 9, wherein said ejection means comprises an ejection button positioned on the top portion of the casing, biased in a first position by a compression spring.

11. The apparatus in claim 10, wherein said ejection button when unbiased in a second position causes the ejection shaft to extend and move said ejection rod from the stowed position to said expulsion position.

12. The apparatus in claim 5, wherein said motor actuation means comprises a button positioned on the top portion of the casing biased in an open position by a compression spring.

13. The apparatus in claim 12, wherein said motor actuation means, when unbiased in a closed position, actuates said gear motor, thereby rotating the primary drive shaft to rotate said cutting tool.

14. The apparatus in claim 1, wherein said ejection means is disposed adjacent to said motor actuation mean on the top portion of the casing.
